(19) United States
(12) Patent Application Publication
(10) Pub. No.: US 2010/0080278 A1
(43) Pub. Date: Apr. 1, 2010

(54) FILTER STRUCTURE IMPLEMENTATION RELATING TO A LINEAR SYSTEM SOLUTION

(75) Inventors: Shue-Lee Chang, San Jose, CA (US); Lin Yang, Fremont, CA (US); Syang-Myau Hwang, Cupertino, CA (US); Qian Zhuang, Fremont, CA (US); Chen Liu, Fremont, CA (US); Jun Lu, Saratoga, CA (US); Jing Li, San Jose, CA (US)

Correspondence Address: FRANK F. TIAN, 331-4A THIRD AVENUE, LONG BEACH, NJ, 07740, US

(73) Assignee: LEGEND SILICON CORP., Fremont, CA (US)

(21) Appl. No.: 12/239,792

(22) Filed: Sep. 28, 2008

(51) Int. Cl. H04L 27/01

(52) U.S. Cl. 375/232

(57) ABSTRACT

A method used in a time domain equalizer is provided. A method comprising the steps of: providing a time domain equalizer comprising a feed forward equalizer and a feedback equalizer; and using a filter circuit or structured implementation to incorporate conjugate gradient iteration in order to calculate a set of coefficients of the time domain equalizer. Whereby matrix times vector operations is converted into filtering using the filter circuit.

### CROSS-REFERENCE TO OTHER APPLICATIONS

The following applications of common assignee and filed on the same day herewith are related to the present application, and are herein incorporated by reference in their entireties:

U.S. patent application Ser. No. ______ with attorney docket number LSFFT-110.

U.S. patent application Ser. No. ______ with attorney docket number LSFFT-102.

U.S. patent application Ser. No. ______ with attorney docket number LSFFT-103.

U.S. patent application Ser. No. ______ with attorney docket number LSFFT-104.

U.S. patent application Ser. No. ______ with attorney docket number LSFFT-105.

U.S. patent application Ser. No. ______ with attorney docket number LSFFT-107.

### FIELD OF THE INVENTION

The present invention relates generally to digital filters, more specifically the present invention relates to a filter structure implementation relating to a linear system solution to calculate filter coefficient for time domain equalizer.

### BACKGROUND

Electronic equipment and supporting software applications typically involve signal processing. For example, home theater, computer graphics, medical imaging and telecommunications all rely on signal-processing technology. Signal processing requires fast math in complex, but repetitive algorithms. Many applications require computations in real-time, i.e., the signal is a continuous function of time, which need be sampled and converted to digital, for numerical processing. A signal processor has to execute algorithms performing discrete computations on the samples as they arrive. The architecture of a digital signal processor (DSP) is optimized to handle such algorithms. The characteristics of a good signal processing engine typically may include fast, flexible arithmetic computation units, unconstrained data flow to and from the computation units, extended precision and dynamic range in the computation units, dual address generators, efficient program sequencing, and ease of programming.

Therefore, it is desirous to improve upon a time domain equalizer by improving the computing efficiency.

### SUMMARY OF THE INVENTION

A filter circuit or structured implementation using conjugate gradient method to calculate filter coefficient for time domain equalizer is provided.

A filter circuit or structured implementation using conjugate gradient method to calculate filter coefficient for time domain equalizer for a multi-leveled VSB receiver is provided.

A filter circuit or structured implementation using conjugate gradient method to calculate filter coefficient for time domain equalizer for an 8-VSB receiver is provided.

A method used in a time domain equalizer is provided. A method comprising the steps of: providing a time domain equalizer comprising a feed forward equalizer and a feedback equalizer; and using a filter circuit or structured implementation to incorporate conjugate gradient iteration in order to calculate a set of coefficients of the time domain equalizer. Whereby matrix times vector operations is converted into filtering using the filter circuit.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of an equalizer structure in accordance with some embodiments of the invention.

FIG. 2 is a first example of a coefficient computing scheme in accordance with some embodiments of the invention.

FIG. 3 is flowchart in accordance with some embodiments of the invention.

FIG. 4 is an example of a digital receiver in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a filter structure implementation relating to a linear system solution to calculate filter coefficient for time domain equalizer. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of using known sequences within the guard intervals being used for a filter structure implementation relating to a linear system solution to calculate filter coefficient for time domain equalizer. The non-processor circuits may include, but are not limited to, a radio receiver, a radio transmitter, signal drivers, clock circuits, power source circuits, and user input devices. As such, these functions may be interpreted as steps of a method to a filter structure implementation relating to a linear system solution to calculate filter coefficient for time domain equalizer. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

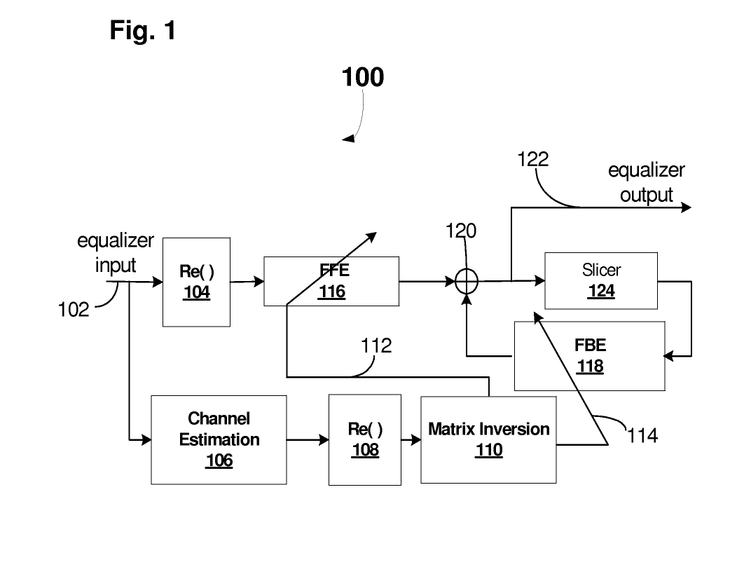

Referring to FIG. 1, a Non-updated Decision Feedback Equalizer 100 is shown. An equalizer input 102 is both input into a real part extractor 104 and a channel estimation block 106. In real part extractor 104, the real portion (versus the imaginary portion) of input 102 is extracted. In channel estimation block 106, both real and imaginary portions of the channel estimation block 106 are subjected to channel estimation. The estimated information is fed into real part extractor 108, the real portion (versus the imaginary portion) of input estimated information is extracted. In turn, the real portion of the estimated information is input into a matrix inversion block 110, wherein a matrix denoting the real portion of the estimated information is inverted.

Matrix inversion block 110 generates two adjustment paths, a first path 112 and a second path 114. First path 112 adjusts a feed forward equalizer block (FFE) 116, which receives the real portion of the equalizer input 102 extracted by block 104. Second path 114 adjusts a feedback equalizer block (FBE) 118, which also receives sliced information from a slicer 124. The outputs of both FFE and 116 and FBE 118 are input into an adder 120. The added inputs are the equalizer output 122. Output 122 is further subjected to slicer 124 and supplied to FBE 118.

As can be seen, the coefficients of the decision feedback equalizer 100 for a VSB receiver such as an 8-VSB receiver could be directly calculated through the real part of the channel estimation. The coefficients can be the optimum solution for the data at exactly that moment. However, if the equalizer input data are noisy, i.e. noise-to-data ratio is deemed high; it is still very difficult to generate good equalizer output data 122 before the Slicer 124. If this is the case, the Slicer 124 will make wrong decisions and the FBE output 118 will not be able to cancel the inter-symbol interferences caused by the post cursor of the channel impulse response. As a result, more noise in equalizer output 122 is generated. The system will go into positive feedback and eventually diverge.

To acquire and update the FFE 116 and FBE 118 coefficients in Time-domain Equalizer (TEQ), a direct calculation algorithm is required. A linear system solution (Ax=b) of dimension N is required, where N is the length of equalizer taps. As can be seen, equivalently a matrix inversion (x=A⁻¹*b) of N by N is required to derive the coefficients. Since the matrix A is not sparse, linear system solution or matrix inverse has a O(N³) complexity. This is extremely difficult to do or solve in real time.

Conjugate Gradient is one of the methods to reduce the complexity and solve such linear system in an iterative manner. However, each iteration still has a complexity of O(N²), and theoretically N times of iteration are needed. Therefore, a hardware based implementation is desirable.

The present invention discloses a filter structure implementation relating to a linear system solution to calculate filter coefficient for time domain equalizer to reduce the complexity with an implementation of Conjugate Gradient in equalizer coefficient acquisition and update.

Exact solution method to calculate FFE 16 and FBE 18 coefficients in time domain equalizer is used. For the exact solution, we have:

$$\begin{matrix}\underline{w} = {\underline{1}}_{Δ} {{{P}_{\underline{\_}}}^{H} ( {P}_{\underline{\_}} {{P}_{\underline{\_}}}^{H} - {P}_{\underline{\_}} {{J}_{\underline{\_}}}_{Δ} {{J}_{\underline{\_}}}_{Δ}^{H} {{P}_{\underline{\_}}}^{H} + \frac{1}{SNR} {{R}_{\underline{\_}}}_{nn} )}^{- 1} & Equ . 1 \\ \underline{b} = \underline{w} {P}_{\underline{\_}} {{J}_{\underline{\_}}}_{Δ} & Equ . 2\end{matrix}$$

where R is the noise self-correlation matrix, J_{Δ} is a matrix of “0”s and “1”s in the form of [O, I, O]^{T}, with O being all zero matrix, and I being unity or identity matrix; n_{f}=FFE length, n_{b}=FBE length, Δ=a proper delay and

$${P}_{\underline{\_}} = [ \begin{matrix}{h}_{- {k}_{1}} & … & {h}_{0} & … & {h}_{{k}_{2}} & 0 & … & … & 0 \\ 0 & {h}_{- {k}_{1}} & … & {h}_{0} & … & {h}_{{k}_{2}} & 0 & … & 0 \\ & & & & & ⋮ & & & \\ 0 & 0 & … & … & {h}_{- {k}_{1}} & … & {h}_{0} & … & {h}_{{k}_{2}}\end{matrix} ] \qquad Equ . 3$$

h is the channel impulse response, with h represented as follows:

h=[h₋ₖ₁, h₋ₖ₁₊₁ . . . h₀, h₁, . . . , hₖ₂] representing channel impulse response.

The above algorithm includes a solution for a N dimensional linear system. Using conjugate gradient, the linear system can be solved in N iterations. In each iteration, a matrix A times or multiplies a vector operation is needed, where the matrix:

$$A = ( {P}_{\underline{\_}} {{P}_{\underline{\_}}}^{H} - {P}_{\underline{\_}} {{J}_{\underline{\_}}}_{Δ} {{J}_{\underline{\_}}}_{Δ}^{H} {{P}_{\underline{\_}}}^{H} + \frac{1}{SNR} {{R}_{\underline{\_}}}_{nn} ) \qquad Equ . 4$$

The vector is represented as d. The calculation of matrix A itself also need matrix times matrix operations. As can be seen, matrix A is symmetric and positive definite.

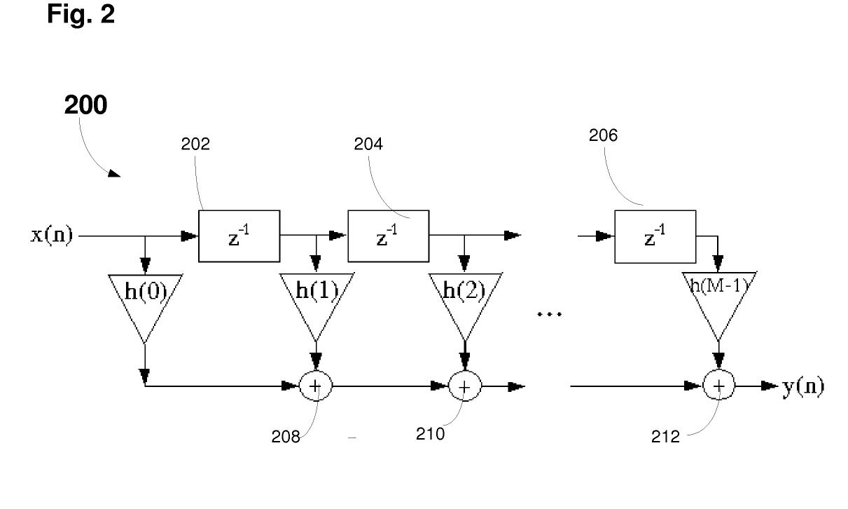

Referring to FIG. 2, a filter based structure 200 to implement in each iteration of the conjugate gradient process is described ed to solve the linear system of FIG. 1. The vector d of FIG. 1 is used as the filter coefficient in each tap, described as h herewith. In other words,

d=h=h(0)+h(1)+h(2)+ . . . +h(M−1) Equ. 5

The channel impulse response is fed through the filter, described as x(n).

x(n) is delayed by a first delay 202. In turn, the first delay is delayed by a second delay 204. The delay continues to progress until the (M−1)th delay 206. Furthermore, x(n) is multiplied or subjected to by h(0). x(n) is delayed and multiplied by h(1). x(n) is twice delayed and multiplied by h(1). Similar delays and multiplications occur and progresses to x(n) being (M−1)th delayed and multiplied by h(M−1). In addition, a first adder 208 sums up:

x(n)h(0)+x(n)h(1)z⁻¹ Equ. 5

A second 210 sums up:

x(n)h(0)+x(n)h(1)z⁻¹+x(n)h(+)z⁻² Equ. 6

Similar sums are performed by circuit 200 or progresses to a (M−1)th adder 212, we get:

y(n)=x(n)h(0)+x(n)h(1)z⁻¹+x(n)h(2)z⁻²+ . . . +x(n)h(M−1)z^{-(M-1)} Equ. 7

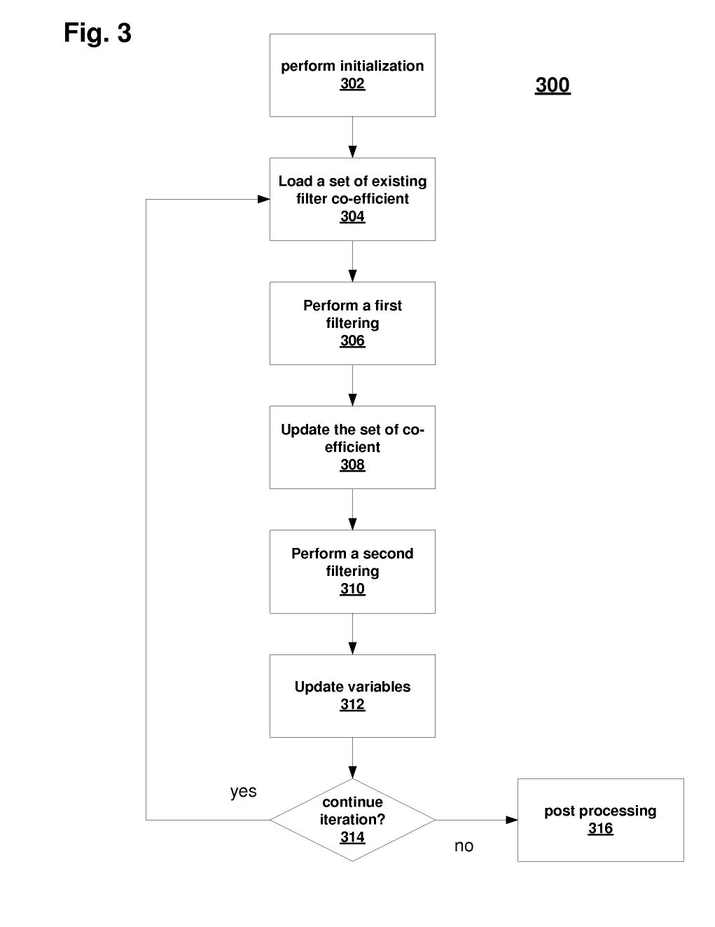

As can be appreciated, when filter structure is used, it is not necessary to calculate matrix A. Instead, the present invention uses double time filtering operations, only channel impulse response, and initial value of FFE coefficient w, are needed during the whole process. Furthermore, other operations, for example update iteration or post processing steps as shown in FIG. 3 infra, in the conjugate gradient iteration can also reuse this filter structure to further reduce the hardware complexity and cost.

The present invention provides a filter circuit structure incorporating conjugate gradient iteration. The filter circuit structure converts at least one matrix times vector operation.

Referring to FIG. 3, flow chart 300 depicting an exemplified process of the present invention is shown. Flow chart 300 describes a process performed within matrix inversion block 110 of FIG. 1. An initialization is performed (Step 302). Load a set of existing filter co-efficient into there respective locations, i.e. in h(0), . . . , h(M−1) in their respective positions as shown in FIG. 2 (Step 304). Perform a first filtering in channel estimation and obtain results as shown in FIG. 2 (Step 306). Update the set of co-efficient based upon the results (Step 308). Perform a second filtering in channel estimation and obtain results (Step 310). Update variables including that which is depicted in FIG. 2 (Step 312). Based upon a set of predetermined criteria, a determination is made as to whether to continue this iteration process (Step 314). If it is determined that no more iteration is necessary, the instant process progresses to post processing such as obtaining FBE co-efficient or FFE co-efficient (Step 316). Otherwise, the process reverts back to Step 304.

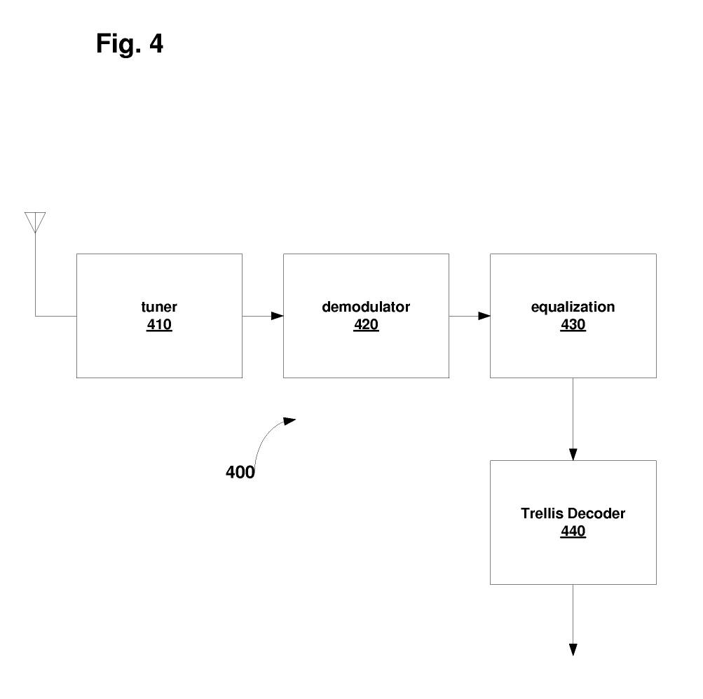

Referring to FIG. 4, a block diagram of a conventional digital television receiver 400, which can process a VSB signal, is shown. The receiver may be a multi-level variable side band (VSB) receiver. The digital television receiver 400 includes a tuner 410, a demodulator 420, an equalizer 430, and a TCM (Trellis-coded Modulation) decoder 440. TCM coding may use an error correction technique, which may improve system robustness against thermal noise. TCM decoding may have more robust performance ability and/or a simpler decoding algorithm. The output signal OUT of the TCM decoder 440 may be processed by a signal processor and output as multimedia signals (e.g., display signals and/or audio signals). The present invention is suitable for application in the equalizer 430. However, the present invention is not limited in its use in receiver 400. Other suitable applications are contemplated by the present invention as well.

The decision feedback equalizer (DFE) of the present invention may be a non-updated DFE. The nature of non-updated DFE determines that the training process is necessary.

As can be seen, the present invention uses a conjugate gradient method to calculate the coefficients of a time domain equalizer coefficient in real time. A complexity-reduced CG algorithm, which utilize partial iteration result as an input for the next update, in order to reduce the total iteration number required in each update.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. A method comprising the steps of:
providing a time domain equalizer comprising a feed forward equalizer and a feedback equalizer; and
using a filter circuit or structured implementation to incorporate conjugate gradient iteration in order to calculate a set of coefficients of the time domain equalizer;
whereby matrix times vector operations is converted into filtering using the filter circuit.

2. The method of claim 1 further comprising the step of loading a set of existing filter coefficients into the filter circuit.

3. The method of claim 2 further comprising the step of performing a first filtering.

4. The method of claim 3 further comprising the step of updating the set filter coefficients.

5. The method of claim 2 further comprising the step of performing a second filtering.

6. The method of claim 5 further comprising the step of updating the set filter coefficients.

7. The method of claim 1 is used in a VSB receiver.

8. The method of claim 1 is used in an 8-VSB.

9. A receiver comprising:
a time domain equalizer comprising a feed forward equalizer and a feedback equalizer; and
a method comprising the step of using a filter circuit or structured implementation to incorporate conjugate gradient iteration in order to calculate a set of coefficients of the time domain equalizer;
whereby matrix times vector operations is converted into filtering using the filter circuit.

10. The receiver of claim 9 further comprising the step of loading a set of existing filter coefficients into the filter circuit.

11. The receiver of claim 10 further comprising the step of performing a first filtering.

12. The receiver of claim 11 further comprising the step of updating the set filter coefficients.

13. The receiver of claim 10 further comprising the step of performing a second filtering.

14. The receiver of claim 13 further comprising the step of updating the set filter coefficients.

15. The receiver of claim 9 is a VSB receiver.

16. The receiver of claim 9 is an 8-VSB.
